(19) United States
(12) Patent Application Publication
(10) Pub. No.: US 2007/0124170 A1
(43) Pub. Date: May 31, 2007

(54) PROCESS FOR CONTROL OF RESTRICTED PRODUCT SALES IN ACCORDANCE WITH LEGAL RESTRICTIONS AND EXPEDITED CREATION OF A CUSTOMER LOG

(75) Inventors: Bryan C. Cabell, Rogers, AR (US); Brian James Purscell, Bentonville, AR (US)

Correspondence Address: BLACKWELL SANDERS PEPER MARTIN LLP, 720 OLIVE STREET, SUITE 2400, ST. LOUIS, MO, 63101, US

(73) Assignee: Wal-Mart Stores, Inc., Bentonville, AR (US)

(21) Appl. No.: 11/164,631

(22) Filed: Nov. 30, 2005

(51) Int. Cl. G06Q 10/00; G06Q 20/00; G06K 5/00

(52) U.S. Cl. 705/2; 705/18; 235/380

(57) ABSTRACT

In an effort to control the production of illegal drugs such as methamphetamine, new statutes have placed restrictions on the sale of common cold remedies that contain pseudoephedrine and other precursors used in the production of these illegal drugs. Many common products, such as Sudafed® cold medicine, have been removed from store shelves and are now behind the counter at most pharmacies. These legal restrictions vary from state to state, but most restrict the amount of product that can be purchased by quantity and time. These legal restrictions also require creation of a customer log that often includes the customer's name, address, government-issued photo identification number and/or signature. Clearance of these restricted product sales and creation of the customer log are time consuming tasks that result in long lines during the winter season. The present invention is an automated process to speed up the authorization process and creation of the customer logs. The process can be applied to a single store or multiple stores. The invention also includes a clearance terminal especially adapted for this process.

### BACKGROUND OF THE INVENTION

Illegal production of methamphetamine and/or amphetamine relies upon certain precursors including over the counter cold remedies that contain ephedrine, phenylpropanolamine and/or pseudoephedrine (“PSE”), such as Sudafed® cold medicine. Recent legislation had imposed new restrictions on products that contain PSE and other precursors (hereinafter sometimes referred to as a “Restricted Product or Products”). Many products, such as Sudafed, that were once out on the shelves, are now behind the counter and are sold under strict rules to reduce the amount of Restricted Products that can readily be obtained by criminals.

Many of these new laws require preparation of a customer log for purchases of Restricted Products. The logs contain various types of information, (sometimes hereinafter referred to as “Transaction Data”) which may include: the customer's name, address, telephone number, government-issued photo identification number such as driver's license number or military identification number, date of birth and signature, product(s) purchased, quantity/number of packs of product(s) purchased, grams of PSE or other precursors in the product(s) purchased, number of tablets/packages of product(s) purchased, date of transaction, time of transaction, name and/or identification of the pharmacy associate dealing with the customer and any other information or data that may be required by statute or otherwise. The laws vary and different states have different requirements for the data kept in the customer log.

Some stores are using manual data entry and paper logs which can create delays and long lines at the pharmacy counter during the winter season. Wal-Mart Stores, Inc., the assignee of the present application, is currently using a semi-automated system known as TaSCO that requires manual entry of the customer's name, address and drivers license. However, the TaSCO system needs to be streamlined to cut down on the amount of time it takes to authorize the purchase of a Restricted Product. Even the TaSCO system sometimes results in long lines and impatient customers during the winter season. Anything that reduces the amount of time necessary to authorize/deny sales and create the statutorily mandated customer log will improve the system and shorten or eliminate the long lines.

### SUMMARY OF THE INVENTION

The present invention has two embodiments. One embodiment is a system designed for a single store and the other embodiment is a system for multiple stores. The system for a single store includes a clearance terminal, typically but not necessarily, located behind the pharmacy counter. (The clearance terminal may also be sometimes referred to as a local clearance terminal because it is located in the store.) The clearance terminal may be a personal computer with a CPU, an alpha-numeric data input device and an integrated government-issued photo identification card reader. The clearance terminal may also include a product scanner. The product scanner may also be able to read the data stored on the government-issued photo identification card. The alpha-numeric data input device could be a touch screen which also functions as a monitor. If the alpha-numeric data input device is a keyboard, the clearance terminal will also need a monitor. In some situations, the clearance terminal may be combined with a cash register, point of sale (“POS”) system or other check out station. Legal restrictions, which may vary from state to state, are inputted into the memory of the clearance terminal. These restrictions may include minimum age requirements and/or quantity limits.

Each customer that wishes to purchase a Restricted Product that is located behind the counter approaches the clearance terminal and asks a pharmacy associate for the Restricted Product, such as Sudafed cold medicine. The pharmacy associate locates the product and then scans the customer's government-issued photo identification card through the card reader to electronically enter the customer's name, address and government-issued photo identification number. The government-issued photo identification card scan greatly speeds up the data entry process because the scan eliminates much of the cumbersome manual data entry for the required customer identification information. Other open field data not previously populated by the government-issued photo identification card scan, such as the customer's telephone number or any other information that may be required by a particular state, may then be manually inputted in the clearance terminal, if required. The bar code of the Restricted Product is scanned or the pharmacy associate keys in the product's universal product code to input product identification data. The number of packs of the Restricted Product is then inputted into the clearance terminal, if applicable. The product weight may then be calculated based on the product identification data and the product quantity. The clearance terminal then validates whether the proposed sale of the Restricted Product is compliant with the legal restrictions previously inputted into the memory of the clearance terminal. If the sale is authorized, the customer may sign their name on an electronic signature device which is preferred or they may sign a paper log. The pharmacy associate inputs their identification data into the clearance terminal. The customer then pays for the Restricted Product(s).

Payment may be made at a separate cash register or the local clearance terminal may include a cash register and POS software. The clearance terminal stores relevant data in memory and creates an electronic transaction log of the entire sales transaction which may include date, time, product identification data for the Restricted Product that was purchased, the product quantity data, the customer identification data including information from the government-issued photo identification card scan and additional customer identification data that may be manually inputted, the customer's signature, the weight of the precursor in the product, the pharmacy associate's identification data, and any other related data that may be required by statute or otherwise like the date and time of the transaction. The electronic transaction log may be printed out for review by law enforcement authorities or any other legally authorized person or agency. The electronic transaction log may be made available in electronic format to be reviewed by law enforcement authorities or any other legally authorized person or agency. The electronic transaction log may be electronically transmitted to a law enforcement agency or any other legally authorized person or agency.

With the addition of a central transaction log at a central data base, this process can be used to control Restricted Product sales at multiple stores, described below in more detail.

### BRIEF DESCRIPTION OF THE DRAWING

FIGS. 1A and 1B are flow charts of the process for control of Restricted Product sales in accordance with legal restrictions and expedited creation of a customer log at a single store.

FIG. 2 is a block diagram of a multi-store system using a central data base.

FIGS. 3A and 3B are flow charts of the process for control of Restricted Product sales at multiple stores using the central data base of FIG. 2.

FIG. 4A is a schematic drawing of the hardware used in a local clearance terminal using a touch screen as the primary alpha-numeric data entry device.

FIG. 4B is a schematic drawing of the hardware used in an alternative embodiment of a local clearance terminal using a keyboard as the primary alpha-numeric data entry device.

### DETAILED DESCRIPTION OF THE INVENTION

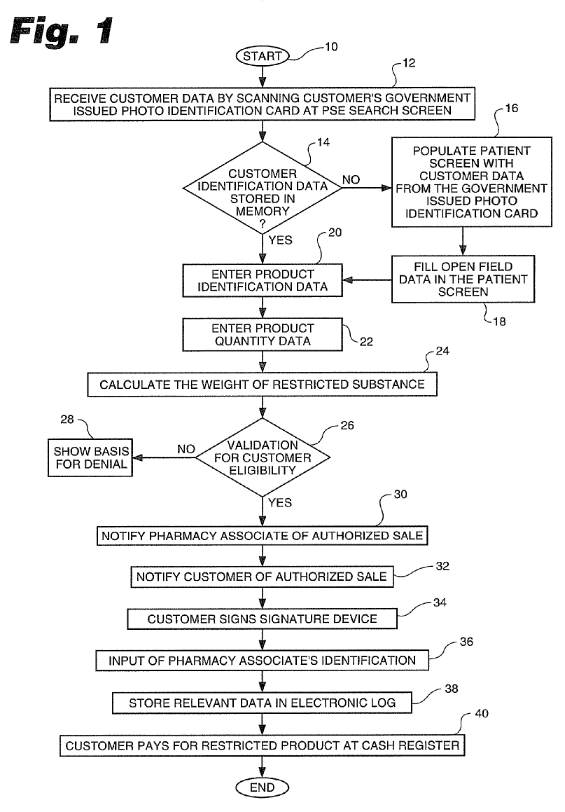

FIG. 1 is a flow chart of the process for control of product sales in accordance with legal restrictions and expedited creation of a customer log at a single store. Legal restrictions for Restricted Products and exempt products and respective product identification data must be loaded into the memory of the local clearance terminal.

Restricted Products are behind a counter, typically at a pharmacy. A customer must approach the counter and get the attention of a pharmacy associate. (The term “Pharmacy Associate” as used hereinafter is intended to be broadly construed and includes a pharmacist, a pharmacy technician, a pharmacy associate, a pharmacy intern, a cashier or any other person using the clearance terminal.) The customer then tells the Pharmacy Associate the names of one or more Restricted Products that they wish to purchase. The Pharmacy Associate then moves to the clearance terminal and so does the customer, if not already at this location. The clearance terminal may be a personal computer having a CPU, monitor, keyboard, government-issued photo identification card reader and optionally a product scanner. If the personal computer uses a touch screen for alpha-numeric data entry, the touch screen can also serve as a monitor and no keyboard is required.

The Pharmacy Associate initiates the start sequence, box 10, on the local clearance terminal to request authorization to sell a Restricted Product which may be denied if the proposed sale violates legal restrictions. In most cases, the clearance terminal will be located on the counter at the pharmacy with the customer on one side and the Restricted Products on the other side.

The Pharmacy Associate asks the customer for their government-issued photo identification card which is scanned through a card reader to input the customer's name, address, government-issued photo identification number and any other relevant data into the clearance terminal memory. The data on the customer's government-issued photo identification card may be stored in various formats including: one dimensional barcode technology (1D barcode); two dimensional barcode technology (2D barcode); magnetic strips; the memory of an embedded integrated circuit on a smart card; or printed information printed on the card itself. The government-issued photo identification card scan is a time saving way to input customer identification data into the clearance terminal memory and is not currently practiced, to applicant's knowledge, in connection with the sale of Restricted Products, legal compliance and the creation of customer logs which are mandated by statute. Government-issued photo identification card readers are known to those skilled in the art. See products offered by NCR Corporation in Dayton, Ohio, www.ncr.com. Parsing software that reads government-issued photo identification cards and populates a blank form with data are also known and must be capable of reading the electronic data on the customer's government-issued photo identification card. See programs offered by Positive Access Corporation in Eden Prairie, Minn. www.positiveaccess.com. As used herein, the term “card reader” means an electronic input device that is: a) of the “swipe” variety, suitable for reading a memory on a card or card-like device; b) a scanner that is suitable for reading a barcode, such as a magnetic strip reader; c) a proximity card reader; d) a smartcard reader; or e) optical characteristic recognition (OCR) reader. Any magnetic or electronic device suitable for receiving information from the government-issued photo identification card is meant to be included in the term “card reader;” however, the term “card reader” specifically excludes manual data entry by typing on a keyboard.

The local clearance terminal then decides, at box 14, whether the customer is an existing customer of the pharmacy or is a new customer. Existing customers have a complete patient identification profile (also sometimes referred to as customer identification data) already stored in the memory of the clearance terminal or the pharmacy customer profile data base, described below. New customers do not have a pre-existing customer profile in memory. If the customer is not an existing customer, the clearance terminal displays a patient screen, box 16, to the Pharmacy Associate that has been populated with as much customer identification data as can be read from the customer's government-issued photo identification card scan. The Pharmacy Associate asks the customer for any additional data (sometimes referred to as “open field data”) that may be necessary to fill in the new patient screen, box 18. When the information is entered, and if the patient screen is fully populated, the data is stored in the memory of the clearance terminal.

The “government-issued photo identification card” means a photo identification card issued by Federal or State government, such as driver licenses, State identification cards, U.S. Military Photo ID Cards or passports. If the government-issued photo identification card is not available to be scanned, the customer identification data must be manually entered which slows down the process and is not the preferred procedure.

After the patient profile screen has been populated with all necessary customer identification data, the Pharmacy Associate scans the product bar code or keys in the universal product code (“UPC”), box 20. In some stores, a product identification card is removed from a dispenser on the shelf and this card is given to the Pharmacy Associate who scans the product bar code or keys in the UPC from this product identification card. In either situation, this product information data of the Restricted Product that the customer wishes to purchase is stored in the memory of the clearance terminal. The Pharmacy Associate then keys in the product quantity data, box 22, i.e. one pack, two packs, etc., to input this data into the memory of the clearance terminal.

Simple systems may operate with product quantity alone, but some states require entry of the weight of the restricted substance. If necessary, the clearance terminal may calculate the weight of the restricted substance 24 based on the product identification data of the product selected by the customer and the product quantity data previously inputted into the memory. The clearance terminal then validates, box 26, whether the proposed sale of the Restricted Product selected by the customer is compliant with the legal restrictions previously stored in memory. The clearance terminal retrieves previous transaction data for the same customer from the data base to validate whether the proposed sale is compliant with the legal restrictions. If the proposed sale is not in compliance, a message 28 appears on the monitor explaining why the proposed sale has been denied. The sale may be denied for any number of reasons, such as the customer being under age or has previously purchased a Restricted Product within a prohibited time interval at that store. If the sale has been authorized by the clearance terminal, a message, box 30, is displayed on the monitor and the customer is notified, box 32, that the sale has been approved. The customer then signs his name on a paper log or on an electronic signature device, box 34. The Pharmacy Associate enters their identification data, box 36, typically by keying in a personal ID number.

The clearance terminal then stores all Transaction Data in the memory of an electronic transaction log, box 38, including the customer identification data, the open field data, the product identification data of the product(s) selected by the customer, the product quantity data, the product weight of the restricted substance, the customer's electronic signature, the Pharmacy Associate personal identification data and other Transaction Data, such as date and time. The customer then pays for the Restricted Products at a cash register, box 40. In an advanced system, the cash register may be integrated into the local clearance terminal. The customer can then leave the store.

In many pharmacies, there is already a data base server with customer profiles stored in memory to facilitate filing of customer prescriptions. The present invention may utilize the existing pharmacy customer profile data base to facilitate sales of Restricted Products. In such an integrated system, when the local clearance terminal looks for an existing customer profile, box 14, the system first searches the memory of the customer log at the local clearance terminal and then searches the memory of the pre-existing pharmacy customer profile data base. If the customer profile is not found in either memory, then the missing customer identification data on the patient screen is automatically populated, box 16, with data obtained from the government-issued photo identification card scan. The system then proceeds to the box 18 and thereafter as previously described.

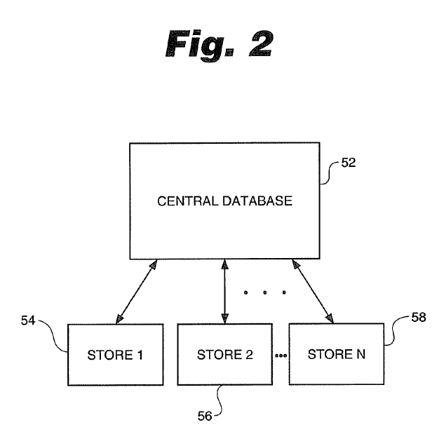

Obviously, a customer can go to another store down the street to buy more Restricted Products, but such a repetitive process is time consuming. The present legislation is an attempt to reduce the production of “meth” as it is commonly called on the street. The second embodiment of this invention allows multiple stores to network their information and help defeat the aforementioned repetitive purchase strategy used by criminals. This multiple store network using a central data base, as described in FIG. 2, is also believed to be new.

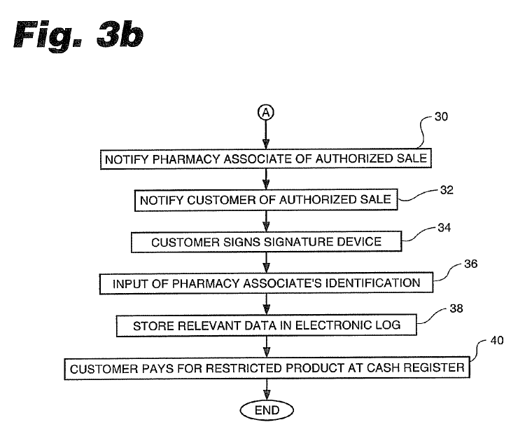

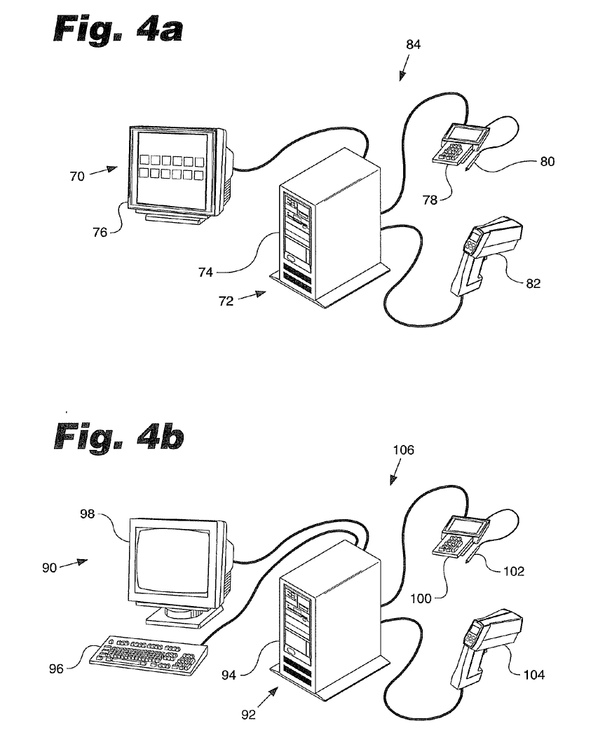

FIG. 2 is a block diagram of a multi-store system 50 using a central data base 52. The first store 54 has at least one local clearance terminal as described above which will typically be located at the pharmacy counter. Two embodiments, 70 and 90, of the local clearance terminal are also shown in FIGS. 4A and 4B described below. The second store 56 also has at least one local clearance terminal. Store_{N} 58 represents any number of additional stores in the multi-store system that also have at least one local clearance terminal. Each local clearance terminal communicates with the central data base 52 to create a master electronic log of all transactions in all stores. This multi-store system using a master electronic log will defeat the criminal that goes from store to store to accumulate a large supply of Restricted Products.

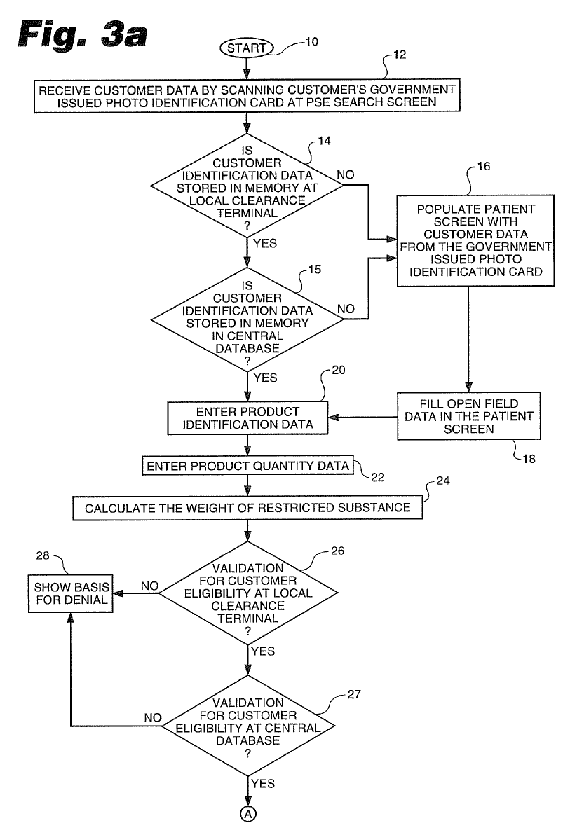

FIGS. 3A and 3B are flow charts of the process for control of Restricted Product sales at multiple stores using the central data base 52 of FIG. 2. The multi-store builds on the process of flow charts 3A and 3B. Like steps will be identified with like numbers.

After the government-issued photo identification card scan, box 12, a local clearance terminal determines if the customer identification data from the card scan is stored in the memory of the local clearance terminal at the first store 54. If the customer identification data is not in the local memory at the first store 54, the local clearance terminal queries the master transaction log, box 15, of the central data base 52 to see if the customer identification data is in the memory of the master transaction log. The local clearance terminal can be connected to the central data base via a network, a modem, or any other communicational method. If the customer identification data is in either memory, the program advances to entry of product identification data, box 20. However, if the customer identification data is not in either memory, the new patient screen will be populated with customer identification data from the government-issued photo identification card scan, box 16. Any other required open field data will be manually inputted, box 18. The process then goes to box 20 for entry of product identification data.

The process is the same through the steps 22, 24 and 26. If the validation for customer eligibility, box 26, at the local clearance terminal is clear, the master transaction log must also be queried, box 27, to make sure the customer has not made a prior purchase at another store that would cause the present purchase to be denied. If both the local clearance terminal and the master transaction log at the central data base authorize a sale, the process moves to box 30 and thereafter to complete the sale. The new transaction should be updated to the central data base.

FIG. 4A is a schematic drawing of the hardware used in a local clearance terminal 70 using a touch screen 76 as the primary alpha-numeric data entry device. The local clearance terminal 70 includes a personal computer 72, with a CPU 74, the touch screen 76, an electronic signature capture device 78, with pen 80, and a bar code scanner 82. This embodiment of a local clearance terminal could also include a keyboard, but it would be redundant of the touch screen 76. The term “Data Entry Module 84” as used in connection with the local clearance terminal 70, includes the touch screen 76, the electronic signature capture device 78 and the bar code scanner 82.

FIG. 4B is a schematic drawing of the hardware used in an alternative embodiment of a local clearance terminal 90 using a keyboard 96 as the primary alpha-numeric data entry device. The local clearance terminal 90 includes a personal computer 92 with a CPU 94, a keyboard 96, a monitor 98, an electronic signature capture device 100 with pen 102, and a bar code scanner 104. This alternative embodiment of the local clearance terminal could also include a touch screen, but it would be redundant of the keyboard 96 and the monitor 98. The term “Data Entry Module 106” as used in connection with the local clearance terminal 90 includes the keyboard 96, the electronic signature capture device 100 and the bar code scanner 104.

In large stores with high customer volume, it is desirable to have several local clearance terminals in each store to prevent long lines. One way to configure this system for a single store is to have several local clearance terminals, each with its own personal computer, that are networked to make sure that the validation steps check the memory of the transaction log in each of the individual personal computers. Yet another more economical way to configure multiple clearance terminals in a single store is to have a single personal computer hard wired to several Data Entry Modules, each of which serves as a local clearance terminal for purposes of forming lines to handle a large volume of customers.

What is claimed is:

1. A process for control of restricted product sales at a single store in accordance with legal restrictions and expedited creation of a customer log with transaction data required by the legal restrictions, the process comprising the following steps:
receiving customer identification data by electronically inputting the data of a customer's government-issued photo identification card through a card reader;
receiving product identification data for the restricted product selected by the customer;
receiving product quantity data for the restricted product selected by the customer;
validating whether the proposed sale of the restricted product is compliant with the legal restrictions;
notifying the pharmacy associate that the proposed sale is authorized or denied because of a violation of the legal restrictions;
receiving the customer's acknowledgement for an authorized sale of the restricted product;
receiving the pharmacy associate's identification data; and
storing the transaction data for each authorized sale in the memory of an electronic transaction log.

2. The process of claim 1 further including, receiving open field data not previously populated by the government-issued photo identification card scan and storing the open field data for each transaction in the memory of the electronic transaction log.

3. The process of claim 1 further including, receiving the customer's acknowledgement by receipt of an electronic signature on an electronic signature device and storing the electronic signature for each transaction in the memory of the electronic transaction log.

4. The process of claim 1 further including, calculating the product weight of a restricted substance at the clearance terminal based on the product identification data of the restricted product selected by the customer and storing the product weight of the restricted substance for each transaction in the memory of the electronic transaction log.

5. The process of claim 1 further including the step of printing the electronic transaction log for review by authorized personnel.

6. The process of claim 1 further including the step of permitting electronic access to the electronic transaction log by authorized personnel.

7. The process of claim 1 further including the step of transmitting the data stored in the electronic transaction log to authorized personnel.

8. A process for control of restricted product sales at a single store in accordance with legal restrictions and expedited creation of a customer log having transaction data required by the legal restrictions, the process comprising the following steps:
receiving customer identification data by scanning the customer's government-issued photo identification card through a card reader at a local clearance terminal;
receiving open field data not previously populated by the government-issued photo identification card scan at the local clearance terminal, if required by the legal restrictions previously stored in the memory of the local clearance terminal;
receiving product identification data for the restricted product selected by the customer at the local clearance terminal;
receiving product quantity data for the restricted product selected by the customer at the local clearance terminal;
validating whether the proposed sale of the restricted product is compliant with legal restrictions previously stored in a memory of the local clearance terminal;
notifying the pharmacy associate that the proposed sale is authorized or denied because of a violation of the legal restrictions;
receiving the customer's acknowledgement for an authorized sale of the restricted product at the local clearance terminal;
receiving the pharmacy associate's identification data at the local clearance terminal; and
storing the transaction data for each authorized sale in the memory of an electronic transaction log at the local clearance terminal.

9. The process of claim 8 further including, receiving the customer's acknowledgement by receipt of an electronic signature on an electronic signature device for each authorized sale and storing the electronic signature for each transaction in the memory of the electronic transaction log at the local clearance terminal.

10. The process of claim 9 further including, transmitting and storing the transaction data from each authorized sale from a local clearance terminal in each store to the memory of the electronic transaction log at a central data base.

11. A process for control of restricted product sales at a single store in accordance with legal restrictions and expedited creation of a customer log having transaction data required by the legal restrictions, the process comprising the following steps:
receiving customer identification data by scanning the customer's government-issued photo identification card through a card reader at a local clearance terminal;
receiving open field data not previously populated by the government-issued photo identification card scan at the local clearance terminal;
receiving identification data for the restricted product selected by the customer at the local clearance terminal;
receiving product quantity data at the local clearance terminal;
calculating the product weight of a restricted substance at the clearance terminal based on the product identification data of the product selected by the customer and the product quantity data;
validating whether the proposed sale of the restricted product is compliant with legal restrictions previously stored in a memory of the local clearance terminal;
notifying the pharmacy associate that the proposed sale is authorized or denied because of a violation of the legal restrictions;
receiving the customer's electronic signature for an authorized sale of a restricted product at the local clearance terminal;
receiving the pharmacy associate's identification data at the local clearance terminal; and
storing the transaction data for each authorized sale in a memory of an electronic transaction log at the local clearance terminal.

12. The process of claim 11 further including, transmitting and storing the transaction data from each authorized sale from each local clearance terminal in each store to the memory of the electronic transaction log at a central data base.

13. A clearance terminal comprising:
a personal computer having a CPU and an alpha-numeric data entry device;
a government-issued photo identification card reader to read card data and transmit the card data to the personal computer;
a scanning device to read product bar code and transmit the bar code data to the personal computer; and
means for determining the customer's eligibility to a restricted product sale.

14. The clearance terminal of claim 13 further including an electronic signature capture device to receive and transmit a customer's signature to the personal computer.

15. The clearance terminal of claim 14 further including an integrated cash register.

16. A clearance terminal comprising:
a personal computer having a CPU and a touch screen;
a government-issued photo identification card reader to read card scanned data and transmit the card scanned data to the personal computer;
a scanning device to read product bar code and transmit the bar code data to the personal computer; and
an electronic signature capture device to receive and transmit a customer's signature to the personal computer.

17. The apparatus of claim 16 further including an integrated cash register.

18. A process for control of restricted product sales at multiple stores in accordance with legal restrictions and expedited creation of a master transaction log, in a central data base the process comprising the following steps:
receiving customer identification data by scanning the customer's government-issued photo identification card through a card reader at a local clearance terminal located in a store;
receiving open field data not previously populated by the government-issued photo identification card scan at the local clearance terminal;
receiving product identification data of the restricted product selected by the customer at the local clearance terminal;
receiving product quantity data at the local clearance terminal;
calculating the product weight of a restricted substance at the local clearance terminal based on the production identification data and the product quantity data;
validating whether the proposed sale of the restricted product is compliant with the legal restrictions previously stored in the memory of the local clearance terminal;
validating whether the proposed sale of the restricted product is compliant with the legal restrictions previously stored in the memory of the master transaction log in the central data base;
notifying the pharmacy associate at the local clearance terminal in the store that the proposed sale is authorized or denied because of a violation of the legal restrictions;
receiving the customer's electronic signature for an authorized sale of a restricted product at the local clearance terminal;
receiving the pharmacy associate's identification data at the local clearance terminal;
storing the transaction data from each authorized sale in an electronic transaction log at the local clearance terminal; and
transmitting and storing the transaction data from each authorized sale from each local clearance terminal in each store to a memory of a master electronic transaction log at the central data base.

19. The process of claim 18 further including the step of printing the electronic transaction log in the central data base for review by authorized personnel.

20. The process of claim 18 further including the step of permitting electronic access by authorized personnel to the electronic transaction log in the central data base.

21. The process of claim 18 further including the step of transmitting the data stored in the electronic transaction log in the central data base to authorized personnel.

22. A process for control of restricted product sales at multiple stores in accordance with legal restrictions and expedited creation of a master customer log, the process comprising the following steps:
receiving customer identification data by scanning the customer's government-issued photo identification card through a card reader at a local clearance terminal located in a store;
receiving open field data not previously populated by the government-issued photo identification card scan at the local clearance terminal located in a store;
receiving product identification data for the restricted product selected by the customer at the local clearance terminal located in a store;
receiving product quantity data at the local clearance terminal located in a store;
validating whether the proposed sale of the restricted product is compliant with the legal restrictions at the local clearance terminal and with a master transaction log at a central data base;
notifying the pharmacy associate at the local clearance terminal in the store that the proposed sale is authorized or denied because of a violation of the legal restrictions;
receiving the customer's acknowledgement for an authorized sale of a restricted product at the local clearance terminal located in the store;
receiving the pharmacy associate's identification data at the local clearance terminal located in the store; and
transmitting the transaction data from each authorized sale from all terminals in all stores to the memory of the master electronic transaction log at the central data base.

23. The process of claim 22 further including the steps of calculating the product weight of a restricted substance at the local clearance terminal located in the store based on the production identification data and the product quantity data and transmitting the product weight of the restricted substance to the memory of the electronic transaction log at the local clearance terminal and the electronic transaction log in the central data base for each authorized sale from all terminals in all stores.

24. A process for control of restricted product sales at a single store in accordance with legal restrictions and expedited creation of a customer log containing transaction data required by the legal restrictions, the process comprising the following steps:
receiving transaction data for an authorized sale selected from the group consisting of: customer identification data by scanning the customer's government-issued photo identification card through a card reader, open field data not previously populated by the government-issued photo identification card scan, identification data for the restricted product selected by the customer, product quantity data, a product weight of a restricted substance in the restricted product, the customer's electronic signature for an authorized sale of the restricted product, a pharmacy associate's identification data, the date and time of an authorized sale, other data required by statute and combinations thereof;
calculating the product weight of a restricted substance at the clearance terminal based on the product identification data of the product selected by the customer and the product quantity data;
validating whether the proposed sale of the restricted product is compliant with legal restrictions previously stored in a memory;
notifying the pharmacy associate that the proposed sale is authorized or denied because of a violation of the legal restrictions; and
storing the transaction data for each authorized sale in a memory of an electronic transaction log.

25. A process for control of restricted product sales at multiple stores in accordance with legal restrictions and expedited creation of a master transaction log, in a central data base the process comprising the following steps:
receiving transaction data for an authorized sale selected from the group consisting of: customer identification data by scanning the customer's government-issued photo identification card through a card reader, open field data not previously populated by the government-issued photo identification card scan, identification data for the restricted product selected by the customer, product quantity data, a product weight of a restricted substance in the restricted product, the customer's electronic signature for an authorized sale of the restricted product, a pharmacy associate's identification data, the date and time of an authorized sale, other data required by statute and combinations thereof;
calculating the product weight of a restricted substance at a local clearance terminal based on the production identification data and the product quantity data;
validating whether the proposed sale of the restricted product is compliant with the legal restrictions previously stored in the memory of the local clearance terminal;
validating whether the proposed sale of the restricted product is compliant with the legal restrictions previously stored in the memory of the master transaction log in the central data base;
notifying the pharmacy associate at the local clearance terminal in the store that the proposed sale is authorized or denied because of a violation of the legal restrictions;
receiving the customer's electronic signature for an authorized sale of a restricted product at the local clearance terminal;
receiving the pharmacy associate's identification data at the local clearance terminal;
storing the transaction data from each authorized sale in the memory of an electronic transaction log at the local clearance terminal; and
transmitting and storing the transaction data from each authorized sale from each local clearance terminal in each store to a memory of an master electronic transaction log at the central data base.
